(19) United States
(12) Patent Application Publication
(10) Pub. No.: US 2023/0126112 A1
(43) Pub. Date: Apr. 27, 2023

(54) USER EQUIPMENT AND METHOD OF RESOURCE ALLOCATION OF SAME

(71) Applicant: GUANGDONG OPPO MOBILE TELECOMMUNICATIONS CORP., LTD., Dongguan (CN)

(72) Inventors: Huei-Ming LIN, South Yarra (AU); Yi DING, Dongguan (CN); Zhenshan ZHAO, Dongguan (CN)

(21) Appl. No.: 18/145,720

(22) Filed: Dec. 22, 2022

Related U.S. Application Data
(63) Continuation of application No. PCT/CN2020/102637, filed on Jul. 17, 2020.

(51) Int. Cl. H04W 72/0446; H04L 5/00; H04W 72/40

(52) U.S. Cl. CPC H04W 72/0446; H04L 5/0055; H04W 72/40

(57) ABSTRACT

A user equipment and a method of resource allocation of the same are provided. The method includes performing monitoring on slots of a resource pool and performing non-exclusion of one or more resources in the resource pool from a candidate resource set when at least one of the following is met: the one or more resources in the candidate resource set in the resource pool within a current reservation, a positive acknowledgement (ACK) being detected in a corresponding physical sidelink feedback channel (PSFCH), up on successful decoding or transmission of an ACK response for an associated physical sidelink shared channel (PSSCH) transmission, or non-detection of a negative acknowledgement (NACK) in a corresponding PSFCH. This can improve radio resource utilization.

The present application is a continuation of International Application No. PCT/CN2020/102637, filed Jul. 17, 2020, the entire disclosure of which is incorporated herein by reference.

### BACKGROUND OF DISCLOSURE

### 1. Field of the Disclosure

The present disclosure relates to the field of communication systems, and more particularly, to a user equipment and a method of resource allocation of the same, which can provide a good communication performance and high reliability.

### 2. Description of the Related Art

In the area of wireless communications, several dominant radio access technologies (RATs) are being used today, each targeting different deployment, applications, and purposes. For example, Wi-Fi and Bluetooth are developed and used mainly for very short range or indoor communication with a coverage typically ranging from a few to 50 meters due to their low power transmissions. Wi-Fi and Bluetooth are almost exclusively operating in unlicensed radio frequency spectrum/bands. That is, Wi-Fi and Bluetooth are also wide-area RATs that can provide a service coverage distance of more than 100 kms from a single base station, like the 3rd generation-wideband code division multiple access (3G-WCDMA), 4th generation-long term evolution (4G-LTE), and the most recently developed 5th generation-new radio (5G-NR) mobile networks.

The mobile networks are designed to serve and provide very high data rate and reliable connections to large number of users at the same time. Therefore, the mobile networks are traditionally deployed and operated in licensed spectrum/frequency bands that are exclusive to regional/local telecommunication operators to guarantee their quality of services. However, the licensed frequency bands are usually very expensive to obtained by the operators.

Since the 4G-LTE era and now also for the 5G-NR RATs, the development of the mobile network technologies also progressed on to the unlicensed frequency spectrum/bands, and make use of the frequency bands as supplementary radio resources to the existing licensed carriers to deliver extra data and provide less critical services, as it will need to coexist and share the unlicensed spectrum with other existing RATs like Wi-Fi and Bluetooth devices. Therefore, when operating in the unlicensed frequency spectrum, it is often a regulatory requirement that all devices need to employ a radio channel access scheme that promotes indiscriminating usage and fair spectrum sharing of the unlicensed radio resources for all devices of different RATs to coexist together.

A commonly adopted and the most widely used channel access scheme among devices of different RATs today is a listen-before-talk (LBT) protocol that allows the devices to coexist in the unlicensed spectrum while maintaining the performance of each individual system. As the name suggests, for a device intend to transmit on an unlicensed radio channel using the LBT protocol, it first “listens” in a receiver mode to the radio channel, then performs radio transmission/“talks” if the channel is unoccupied. If the channel is occupied, then the device backs off/waits for a time period before it tries again.

As part of radio channel access and wireless transmission technology for the existing 5G-NR sidelink (SL) communication in a selected mode (as known as mode 2), prior to any radio transmission from a user equipment (UE), the UE performs sensing on a sidelink (SL) resource pool and monitors its usage over a period of time to exclude resources reserved/likely to be used by other UEs. Subsequently, the UE derives a set of candidate resources that can be selected for UE's own transmission(s) with an aim to minimize probability of transmission collision with another UE. Then during SL transmissions using the selected resources, the UE can reserve more resources for its future transmissions. However, according to the current SL resource sensing and monitoring process in mode 2, only the physical sidelink control channel (PSCCH) and physical sidelink shared channel (PSSCH) transmissions and usage are required to be monitored by the resource selecting UE, but not the physical sidelink feedback channel (PSFCH) carrying hybrid automatic repeat request (HARQ) acknowledgement (ACK) and negative acknowledgement (NACK) reports.

Furthermore, in the existing SL resource selection procedure, once a SL transmitter UE receives a HARQ ACK feedback report from a target receiver UE, the remaining resources that are reserved for future transmissions are considered ‘released’ by the original resource reserving UE only, which is the transmitting UE. As such, only the original resource reserving UE can reutilize the remaining reserved but potentially unused resources. But if the original resource reserving UE does not have other SL data to transmit, or the ‘released’ resources are not suitable for new transmissions (e.g. resource size or timing is insufficient for the required QoS target), it would be wasteful to leave these resources completely unused since they are not ‘released’ to any other UEs. Furthermore, when a radio channel is left unutilized in an unlicensed spectrum, it leaves the door open to other radio access technologies (e.g. WiFi and Bluetooth devices) to gain access to the radio resource and loss of access right to the channel. This can cause impacts/loss of channel access rights for other devices (of the same RAT) and prevent them from using already reserved and/or allocated resources for their own transmissions. As a result, this can cause increased latency, reduced data rate and reduced reliability of wireless communication. Moreover, for 5G-NR sidelink UEs, they will need to re-perform resource sensing and (re)selection operation again to reserve sidelink resources and avoid collisions. This will cause further UE processing time and power, as such.

Therefore, there is a need for a user equipment and a method of resource allocation of the same, which can provide a good communication performance and high reliability.

### SUMMARY

An object of the present disclosure is to propose a user equipment and a method of resource allocation of the same, which improve radio resource utilization.

In a first aspect of the present disclosure, a user equipment of resource allocation includes a memory, a transceiver, and a processor coupled to the memory and the transceiver. The processor is configured to perform monitoring on slots of a resource pool and perform non-exclusion of one or more resources in the resource pool from a candidate resource set when at least one of the following is met: the one or more resources in the candidate resource set in the resource pool within a current reservation, a positive acknowledgement (ACK) being detected in a corresponding physical sidelink feedback channel (PSFCH), up on successful decoding or transmission of an ACK response for an associated physical sidelink shared channel (PSSCH) transmission, or non-detection of a negative acknowledgement (NACK) in a corresponding PSFCH.

In a second aspect of the present disclosure, a method of resource allocation of a user equipment includes performing monitoring on slots of a resource pool and performing non-exclusion of one or more resources in the resource pool from a candidate resource set when at least one of the following is met: the one or more resources in the candidate resource set in the resource pool within a current reservation, a positive acknowledgement (ACK) being detected in a corresponding physical sidelink feedback channel (PSFCH), up on successful decoding or transmission of an ACK response for an associated physical sidelink shared channel (PSSCH) transmission, or non-detection of a negative acknowledgement (NACK) in a corresponding PSFCH.

In a third aspect of the present disclosure, a non-transitory machine-readable storage medium has stored thereon instructions that, when executed by a computer, cause the computer to perform the above method.

In a fourth aspect of the present disclosure, a terminal device includes a processor and a memory configured to store a computer program. The processor is configured to execute the computer program stored in the memory to perform the above method.

In a fifth aspect of the present disclosure, a base station includes a processor and a memory configured to store a computer program. The processor is configured to execute the computer program stored in the memory to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth of the present disclosure, a computer program causes a computer to execute the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of resource allocation in a communication network system according to an embodiment of the present disclosure.

FIG. 2 is a flowchart illustrating a method of resource allocation of a user equipment according to an embodiment of the present disclosure.

FIG. 3 is an exemplary illustration of UE monitoring HARQ-ACK response in PSFCH and inclusion of reserved but unused resources as part of resource selection procedure according to an embodiment of the present disclosure.

FIG. 4 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In some embodiments of the present disclosure, a radio resource selection and channel access scheme are provided. Some embodiments aim to improve radio resource utilization and resolve issues in the prior art by minimizing reserved but unused resources from allowing sidelink (SL) transmitter user equipments (UEs) to monitor hybrid automatic repeat request acknowledgement (HARQ-ACK) responses transmitted on a physical sidelink feedback channel (PSFCH), identifying and selecting unused resources and contending for the radio channel access for these resources. In some embodiments, other benefits of adopting the newly invented scheme in 5G-NR sidelink communication include: 1. Creating more transmission opportunities for all radio resource monitoring and selecting UEs and thus increasing system data rate. 2. More available resources mean less collision probability, better utilization of resources means less wastage, accurate measure of channel busy ratio (CBR) will lead to better selection of transmission parameters and therefore better Tx reliability, and more transmission opportunities will provide reduced latency when sharing of unlicensed radio channel with other RATs.

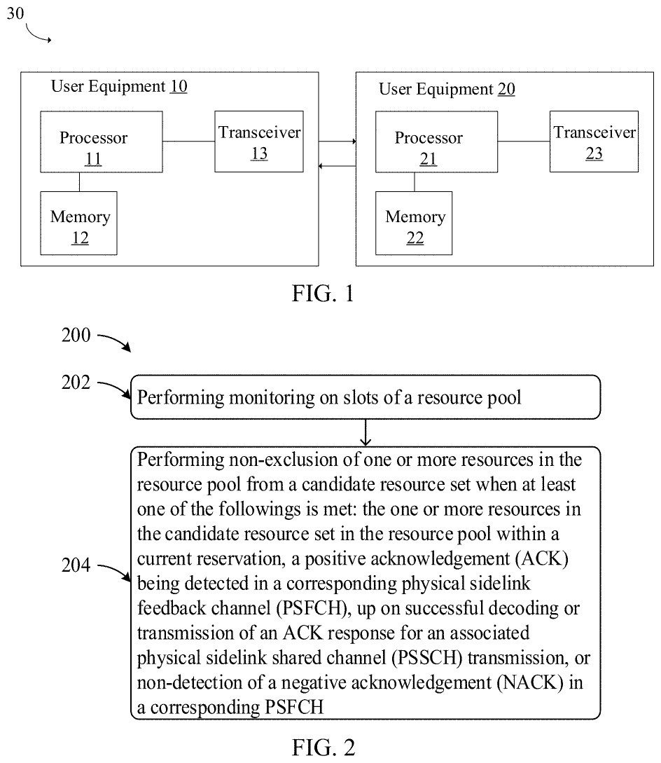

FIG. 1 illustrates that, in some embodiments, user equipments (UE) 10 and 20 of resource allocation in a communication network system 30 according to an embodiment of the present disclosure are provided. The communication network system 30 includes the UE 10 and the UE 20. The UE 10 may include a memory 12, a transceiver 13, and a processor 11 coupled to the memory 12, the transceiver 13. The UE 20 may include a memory 22, a transceiver 23, and a processor 21 coupled to the memory 22, the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) Release 16 and beyond. UEs are communicated with each other directly via a sidelink interface such as a PC5 interface. Some embodiments of the present disclosure relate to sidelink communication technology in 3GPP NR release 16 and beyond.

In some embodiments, the processor 11 is configured to perform monitoring on slots of a resource pool and perform non-exclusion of one or more resources in the resource pool from a candidate resource set when at least one of the following is met: the one or more resources in the candidate resource set in the resource pool within a current reservation, a positive acknowledgement (ACK) being detected in a corresponding physical sidelink feedback channel (PSFCH), up on successful decoding or transmission of an ACK response for an associated physical sidelink shared channel (PSSCH) transmission, or non-detection of a negative acknowledgement (NACK) in a corresponding PSFCH. This can improve radio resource utilization, gaining access to the unlicensed frequency spectrum to allow lower cost for users, and/or provide better user experience from enhanced system performance with less wireless transmission collisions.

In some embodiments, performing the non-exclusion of one or more resources from the candidate resource set in the resource pool within the current reservation comprises performing the non-exclusion of one or more resources from the candidate resource set in the resource pool within the current reservation when a reservation is present in a decoded physical sidelink control channel (PSCCH). In some embodiments, the current reservation comprises a current reservation period, and the reservation present in the decoded PSCCH comprises a resource reservation period field present in the decoded PSCCH. In some embodiments, the processor 11 is configured to perform exclusion of one or more resources from the candidate resource set in the resource pool in a subsequent reservation. In some embodiments, the subsequent reservation comprises a subsequent reservation period.

In some embodiments, the resource pool is network configured or pre-configured. In some embodiments, the resource pool comprises a UE-selected resource pool for sidelink transmission. In some embodiments, monitoring on the slots of the resource pool is performed by decoding a PSCCH, measuring a reference signal received power (RSRP), and/or decoding a sidelink control information (SCI) in a PSSCH. In some embodiments, the SCI comprises a second stage SCI. In some embodiments, the processor 11 is configured to initialize the candidate resource set in the resource pool. In some embodiments, the processor 11 is configured to perform exclusion of one or more resources from the candidate resource set in the resource pool when the one or more resources in the candidate resource set in the resource pool overlaps with resource blocks and/or slots reserved in a decoded PSCCH.

In some embodiments, the transceiver 13 is configured to receive a signaling or pre-configuration for SL transmission. In some embodiments, the signaling comprises a network radio resource control (RRC) configuration signaling. In some embodiments, the pre-configuration comprises the pre-configuration of a UE-selected resource pool. In some embodiments, the processor 11 is configured to report, to a higher layer, a remaining set of one or more candidate resources for a transmission resource selection. In some embodiments, the processor 11 is configured to perform a listen before talk (LBT) to contend for access to a radio channel before a start of each SL transmission using one or more selected resources.

FIG. 2 illustrates a method 200 of resource allocation of a UE according to an embodiment of the present disclosure. In some embodiments, the method 200 includes: a block 202, performing monitoring on slots of a resource pool, and a block 204, performing non-exclusion of one or more resources in the resource pool from a candidate resource set when at least one of the following is met: the one or more resources in the candidate resource set in the resource pool within a current reservation, a positive acknowledgement (ACK) being detected in a corresponding physical sidelink feedback channel (PSFCH), up on successful decoding or transmission of an ACK response for an associated physical sidelink shared channel (PSSCH) transmission, or non-detection of a negative acknowledgement (NACK) in a corresponding PSFCH. This can improve radio resource utilization, gaining access to the unlicensed frequency spectrum to allow lower cost for users, and/or provide better user experience from enhanced system performance with less wireless transmission collisions.

In some embodiments, performing the non-exclusion of one or more resources from the candidate resource set in the resource pool within the current reservation comprises performing the non-exclusion of one or more resources from the candidate resource set in the resource pool within the current reservation when a reservation is present in a decoded physical sidelink control channel (PSCCH). In some embodiments, the current reservation comprises a current reservation period, and the reservation present in the decoded PSCCH comprises a resource reservation period field present in the decoded PSCCH. In some embodiments, the method further comprises performing exclusion of one or more resources from the candidate resource set in the resource pool in a subsequent reservation. In some embodiments, the subsequent reservation comprises a subsequent reservation period. In some embodiments, the resource pool is network configured or pre-configured. In some embodiments, the resource pool comprises a UE-selected resource pool for sidelink transmission.

In some embodiments, monitoring on the slots of the resource pool is performed by decoding a PSCCH, measuring a reference signal received power (RSRP), and/or decoding a sidelink control information (SCI) in a PSSCH. In some embodiments, the SCI comprises a second stage SCI. In some embodiments, the method further comprises initializing the candidate resource set in the resource pool. In some embodiments, the method further comprises performing exclusion of one or more resources from the candidate resource set in the resource pool when the one or more resources in the candidate resource set in the resource pool overlaps with resource blocks and/or slots reserved in a decoded PSCCH. In some embodiments, the method further comprises receiving a signaling or pre-configuration for SL transmission.

In some embodiments, the signaling comprises a network radio resource control (RRC) configuration signaling. In some embodiments, the pre-configuration comprises the pre-configuration of a UE-selected resource pool. In some embodiments, the method further comprises reporting, to a higher layer, a remaining set of one or more candidate resources for a transmission resource selection. In some embodiments, the method further comprises performing a listen before talk (LBT) to contend for access to a radio channel before a start of each SL transmission using one or more selected resources.

In some embodiments of the present disclosure, a method of resource selection and radio channel access is provided. Some embodiments are intended for used by a 5th generation-new radio (5G-NR) sidelink (SL) communication system when operating in unlicensed frequency spectrum. In some embodiments, a SL transport block (TB) transmitter user equipment (Tx-UE) first monitors a usage and reservation status of SL resources of a (pre-)configured resource pool to determine a set of available candidate resources before the Tx-UE performs the selection of resource(s) and contends for the access to the radio channel to use the selected resource(s) for transmission.

In some embodiments, for a 5G-NR UE operating in sidelink resource allocation mode 2 (as known as UE autonomous resource selection) and selecting physical sidelink shared channel (PSSCH) resource(s) for SL transmission in a resource pool, if from monitoring hybrid automatic repeat request-acknowledgement (HARQ-ACK) responses in physical sidelink feedback channel (PSFCH) the UE determines any prior reserved resource by another UE is no longer needed for retransmission of the same TB, the UE considers the remaining resource(s) reserved by the another UE to be unreserved/released, and are hence available for selection for its own sidelink transmission. However, regardless if the unreserved/released resource is selected, the 5G-NR SL UE needs to perform listen-before-talk (LBT) operation to contend for access to the wireless channel. If LBT contention is successful, the UE uses the selected resource for its own sidelink transmission.

In some embodiments, during the monitoring of HARQ-ACK responses in PSFCH, if up on transmission or detection of an acknowledgement (ACK) response, and/or non-detection of a negative acknowledgement (NACK) response, a wireless communicating device of a same or different RAT is allowed to select and/or contend for channel access to one or more of the remaining associated radio resources that are previously reserved (and no longer to be used) by another wireless communicating device.

In details, when a sidelink UE is requested to report a set of candidate resources (SA) to higher layers for PSSCH resource selection (including initial resource selection, re-evaluation and pre-emption procedures), the UE monitors slots belong to the (pre-)configured ‘UE-selected’ sidelink resource pool within a sensing window except for those in which its own transmissions occur.

In some embodiments, if the “UE-selected” sidelink resource pool is (pre-)configured with PSFCH resources (for example when the (pre-)configuration parameter for the period of PSFCH resource within resource pool is set to a non-zero value), the UE performs the following based on decoded physical sidelink control channel (PSCCH), measured reference signal received power (RSRP), and/or decoded 2nd stage sidelink control information (SCI) in PSSCH.

In some embodiments, when the HARQ feedback indicator is enabled in the decoded SCI (for example SCI format 2-A or 2-B) for a PSSCH/PSCCH transmission, the UE performs detection/monitoring of HARQ-ACK responses in the corresponding PSFCH resource.

In some embodiments, the UE should not consider/take into account the set of resource blocks and slots assigned/reserved by the decoded PSCCH during resource exclusion, or the UE does not exclude any single-slot resource from the candidate resource set based on the set of resource blocks and slots assigned/reserved by the decoded PSCCH (reserved but unused resources), when one or more of the following conditions is met: A positive acknowledgement (ACK) is detected in the corresponding PSFCH (for example when unicast is indicated in the decoded 2nd stage SCI). Up on successful decoding or transmission of an ACK response for the associated PSSCH transmission (for example when unicast is indicated in the decoded 2nd stage SCI). Non-detection of negative acknowledgement (NACK) in the corresponding PSFCH (for example when groupcast or HARQ operation with only NACK is indicated in the decoded 2nd stage SCI).

In some embodiments, if a “resource reservation period” field is present in the decoded PSCCH (e.g. SCI format 1-A) with its value set to none-zero, the operation of non-exclusion of single-slot resource from the candidate resource set due to reserved but released/unused resources from monitoring HARQ-ACK responses in PSFCH applies only within the current reservation period. For all other reserved resources in the subsequent reservation period(s) should still consider to be reserved, i.e. not released, or make available for selection and contention by the UE monitoring HARQ-ACK responses in PSFCH. Therefore, these resources should still be excluded from the candidate resource set by the monitoring UE.

In some embodiments, the UE reports the candidate resource set to higher layers for final selection of resource(s) for SL transmission. In some embodiments, the US performs LBT to contend for access to the radio channel before each SL transmission using the selected resource.

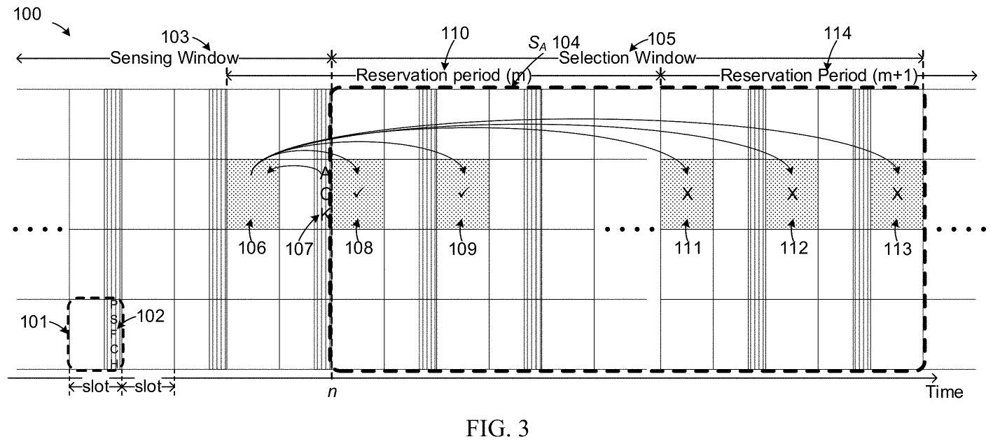

FIG. 3 is an exemplary illustration of UE monitoring HARQ-ACK response in PSFCH and inclusion of reserved but unused resources as part of resource selection procedure according to an embodiment of the present disclosure. FIG. 3 illustrates that in some embodiments, in reference to diagram 100 in FIG. 3, an exemplary illustration of a UE not excluding some of resources already assigned/reserved by another UE from a candidate resource set due to HARQ-ACK feedback during a SL resource selection process is provided. In some embodiments, for a scenario where two 5G-NR sidelink UEs (UE_1 and UE_2) are both operating in UE autonomous selection mode/mode 2, engaging in a SL unicast session with direct communication with each other, and configured with a UE-selected resource pool. For the configured UE-selected resource pool, each SL resource 101 has a duration of a single-slot and PSFCH resources 102 are also configured within the resource pool (with a periodicity of every 2 slots).

FIG. 3 illustrates that in some embodiments, when the UE_1 is triggered to perform SL resource selection at time/slot n, as part of resource selection process of UE autonomous selection mode/mode 2, the UE_1 performs monitoring of SL slots of the configured UE-selected resource pool over a sensing window 103 with a time duration provided by the higher layer, and initializes a set of candidate resources (SA) 104 for a resource selection window 105. During the resource selection process, based on decoded PSCCH and measured RSRP during the sensing window 103, the UE_1 may exclude all single-slot resources that have been announced/reserved by other UEs and fall within the selection window 105 from the candidate resource set 104. For the illustrated example in diagram 100, assume the UE_1 successfully decoded a PSSCH/PSCCH transmission intended for it from the UE 2, prepared a positive acknowledgement, and transmitted the HARQ-ACK response in a PSFCH 107 during the sensing window 103. Based on the decoded PSCCH in a resource 106, the UE_2 can further announce/reserve in SCI two or more resources 108 and 109 in advance for future retransmissions of the same PSSCH TB within a current reservation period 110, in case when the UE_2 fails to receive a positive acknowledge (ACK) in the corresponding PSFCH 107 from the UE_1.

FIG. 3 illustrates that in some embodiments, since the UE_1 successfully decodes the PSSCH/PSCCH transmission in the resource 106 and responds with an ACK in the corresponding PSFCH resource 107, the two remaining reserved resources 108 and 109, which also fall within the selection window 105 of the UE_1, are no longer needed for the future retransmissions of the same PSSCH TB by the UE_2. Hence, from the UE_1's perspective, up on successful decoding or transmission of an ACK response for the PSSCH/PSCCH transmission in the resource 106, the UE_1 considers both resources 108 and 109 are deemed released and available for its own resource selection. As such, both resources 108 and 109 should not be excluded from the candidate resource set SA 104, which is to be reported to the higher layer by the UE_1 according to some embodiments of the present disclosure of the proposed SL resource selection method. If any of these reported resources are selected by the higher layer for SL transmission, the UE_1 then performs LBT operation to gain access to the radio channel before the actual SL transmission using the released resources.

FIG. 3 illustrates that in some embodiments, if the UE_2 also indicates additional resources 111, 112, and 113 into a next reservation period 114 for resource reservation (e.g. by indicating a resource reservation period value other than zero for periodic traffic transmission of new PSCCH TBs) during the PSSCH/PSCCH transmission in the resource 106 beyond its current reservation period 110, the UE_1 may still exclude the reserved resources in the following reservation period from its own resource selection.

FIG. 3 illustrates that in some embodiments, when there is another SL resource selecting UE (UE_3), which is not part of the SL unicast communication between the UE_1 and UE_2, receives resource assignment/reservation information in PSCCH transmitted in the resource 106 and detects the ACK response from the UE_1 in the corresponding PSFCH 107, the similar resource exclusion and selection process to the UE_1 may be followed by the UE_3. That is, if the indicated/reserved resources 108, 109, 111, 112, 113 from the UE_2 fall within the selection window of the UE_3 (i.e., part of the candidate resource set of the UE_3), then the UE_3 may only exclude resources based on the resources 111, 112, and 113, but not due to the resources 108 and 109. Therefore, the UE_3 may still be allowed to contend for the radio channel access to perform SL transmission using the resources 108 and 109.

In some embodiments, in order to maximize resource selection for a SL communication UE and to improve radio resource utilization when operating in an unlicensed frequency spectrum, it is proposed for the SL UE to adopt a new PSFCH monitoring strategy during the resource selection procedure and contend for the access to the radio channel before sidelink transmission. In some embodiments, an overall method of the new UE autonomous resource selection and channel access procedure, which is also applicable for use in SL resource re-evaluation and pre-emption checking, for mode 2 5G-NR SL communication comprises the following.

The UE is configured to receive from network RRC configuration signaling or pre-configuration of a UE-selected resource pool for SL transmission. The UE is configured to monitor in slots of the (pre-)configured UE-selected resource pool by at least decoding PSCCH, measuring RSRP and/or decoding 2nd stage SCI in PSSCH. When the HARQ feedback indicator is enabled in the decoded SCI for a PSSCH/PSCCH transmission, the UE additionally monitors HARQ-ACK response in the corresponding PSFCH resource.

The UE is configured to initialize a candidate resource set and perform exclusion of resource from the set when it overlaps with resource blocks and slots reserved in the decoded PSCCH, except when one or more of the following conditions is met: a positive acknowledgement (ACK) is detected in the corresponding PSFCH, up on successful decoding or transmission of an ACK response for the associated PSSCH transmission, or non-detection of negative acknowledgement (NACK) in the corresponding PSFCH.

When a resource reservation period field is present in the decoded PSCCH and the value is none-zero, the non-exclusion of resource(s) from the candidate resource set applies only within the current reservation period. For all other reserved resources in the subsequent reservation period(s) can be excluded from the candidate resource set. The UE is configured to report the remaining set of candidate resources higher layers for transmission resource(s) selection. The UE is configured to perform LBT to contend for access to the radio channel before the start of each SL transmission using the selected resource(s).

In summary, a radio resource selection and channel access scheme are provided. Some embodiments aim to improve radio resource utilization and resolve issues in the prior art by minimizing reserved but unused resources from allowing sidelink (SL) transmitter user equipments (UEs) to monitor hybrid automatic repeat request acknowledgement (HARQ-ACK) responses transmitted on a physical sidelink feedback channel (PSFCH), identifying and selecting unused resources and contending for the radio channel access for these resources. In some embodiments, other benefits of adopting the newly invented scheme in 5G-NR sidelink communication include: 1. Creating more transmission opportunities for all radio resource monitoring and selecting UEs and thus increasing system data rate. 2. More available resources mean less collision probability, better utilization of resources means less wastage, accurate measure of channel busy ratio (CBR) will lead to better selection of transmission parameters and therefore better Tx reliability, and more transmission opportunities will provide reduced latency when sharing of unlicensed radio channel with other RATs.

Commercial interests for some embodiments are as follows. 1. Gaining access to the unlicensed frequency spectrum to allow lower cost for users. 2. Better user experience from enhanced system performance with less wireless transmission collisions. 3. Providing good communication performance. 4. Providing high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product.

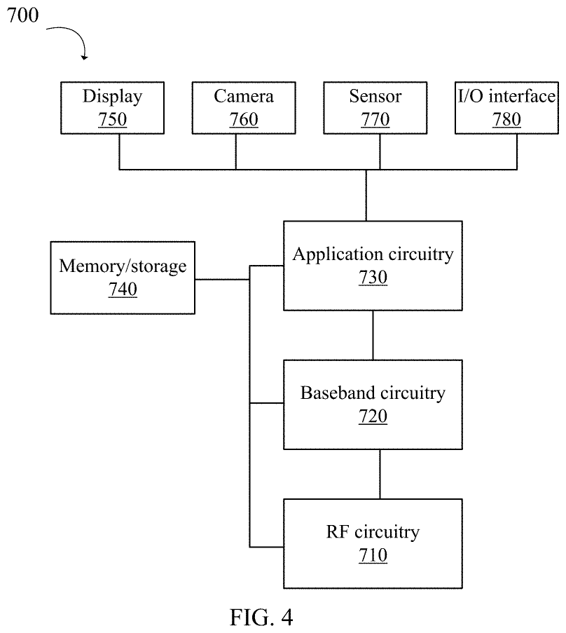

FIG. 4 is a block diagram of an example system 700 for wireless communication according to an embodiment of the present disclosure. Embodiments described herein may be implemented into the system using any suitably configured hardware and/or software. FIG. 4 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A user equipment of resource allocation, comprising:
a memory;
a transceiver; and
a processor coupled to the memory and the transceiver;
wherein the processor is configured to:
perform monitoring on slots of a resource pool; and
perform non-exclusion of one or more resources in the resource pool from a candidate resource set when at least one of the following is met:
the one or more resources in the candidate resource set in the resource pool within a current reservation;
a positive acknowledgement (ACK) being detected in a corresponding physical sidelink feedback channel (PSFCH);
up on successful decoding or transmission of an ACK response for an associated physical sidelink shared channel (PSSCH) transmission; or
non-detection of a negative acknowledgement (NACK) in a corresponding PSFCH.

2. The user equipment of claim 1, wherein performing the non-exclusion of one or more resources from the candidate resource set in the resource pool within the current reservation comprises performing the non-exclusion of one or more resources from the candidate resource set in the resource pool within the current reservation when a reservation is present in a decoded physical sidelink control channel (PSCCH).

3. The user equipment of claim 2, wherein the current reservation comprises a current reservation period, and the reservation present in the decoded PSCCH comprises a resource reservation period field present in the decoded PSCCH.

4. The user equipment of claim 1, wherein the processor is configured to perform exclusion of one or more resources from the candidate resource set in the resource pool in a subsequent reservation.

5. The user equipment of claim 4, wherein the subsequent reservation comprises a subsequent reservation period.

6. The user equipment of claim 1, wherein the resource pool is network configured or pre-configured.

7. The user equipment of claim 1, wherein the resource pool comprises a UE-selected resource pool for sidelink transmission.

8. The user equipment of claim 1, wherein monitoring on the slots of the resource pool is performed by decoding a PSCCH, measuring a reference signal received power (RSRP), and/or decoding a sidelink control information (SCI) in a PSSCH.

9. The user equipment of claim 8, wherein the SCI comprises a second stage SCI.

10. The user equipment of claim 1, wherein the processor is configured to initialize the candidate resource set in the resource pool.

11. A method of resource allocation of a user equipment, comprising:
performing monitoring on slots of a resource pool; and
performing non-exclusion of one or more resources in the resource pool from a candidate resource set when at least one of the following is met:
the one or more resources in the candidate resource set in the resource pool within a current reservation;
a positive acknowledgement (ACK) being detected in a corresponding physical sidelink feedback channel (PSFCH);
up on successful decoding or transmission of an ACK response for an associated physical sidelink shared channel (PSSCH) transmission; or
non-detection of a negative acknowledgement (NACK) in a corresponding PSFCH.

12. The method of claim 11, wherein performing the non-exclusion of one or more resources from the candidate resource set in the resource pool within the current reservation comprises performing the non-exclusion of one or more resources from the candidate resource set in the resource pool within the current reservation when a reservation is present in a decoded physical sidelink control channel (PSCCH).

13. The method of claim 12, wherein the current reservation comprises a current reservation period, and the reservation present in the decoded PSCCH comprises a resource reservation period field present in the decoded PSCCH.

14. The method of claim 11, further comprising performing exclusion of one or more resources from the candidate resource set in the resource pool when the one or more resources in the candidate resource set in the resource pool overlaps with resource blocks and/or slots reserved in a decoded PSCCH.

15. The method of claim 11, further comprising receiving a signaling or pre-configuration for SL transmission.

16. The method of claim 15, wherein the signaling comprises a network radio resource control (RRC) configuration signaling.

17. The method of claim 15, wherein the pre-configuration comprises the pre-configuration of a UE-selected resource pool.

18. The method of claim 11, further comprising reporting, to a higher layer, a remaining set of one or more candidate resources for a transmission resource selection.

19. The method of claim 11, further comprising performing a listen before talk (LBT) to contend for access to a radio channel before a start of each SL transmission using one or more selected resources.

20. A non-transitory machine-readable storage medium having stored thereon instructions that, when executed by a computer, cause the computer to perform a method of resource allocation of a user equipment, comprising:
performing monitoring on slots of a resource pool; and
performing non-exclusion of one or more resources in the resource pool from a candidate resource set when at least one of the following is met:
the one or more resources in the candidate resource set in the resource pool within a current reservation;
a positive acknowledgement (ACK) being detected in a corresponding physical sidelink feedback channel (PSFCH);
up on successful decoding or transmission of an ACK response for an associated physical sidelink shared channel (PSSCH) transmission; or
non-detection of a negative acknowledgement (NACK) in a corresponding PSFCH.
